(19) United States
(12) Patent Application Publication
(10) Pub. No.: US 2006/0197676 A1
(43) Pub. Date: Sep. 7, 2006

(54) APPARATUS AND METHOD FOR BATTERYLESS HIERARCHY REMOTE CONTROL

(76) Inventor: Sterling Smith, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/307,219

(22) Filed: Jan. 27, 2006

Related U.S. Application Data
(60) Provisional application No. 60/593,657, filed on Feb. 2, 2005.

(51) Int. Cl. H04Q 5/22

(52) U.S. Cl. 340/825.69; 340/10.1

(57) ABSTRACT

A batteryless remote control device and associated method is provided. The batteryless remote control device comprises a plurality of buttons; an RFID circuit with a nonvolatile memory, coupled to the buttons; and an antenna, coupled to the RFID circuit, for transceiving an RF signal. The remote control method for a digital home appliance to be remote controlled by a batteryless remote control device comprising the following steps. The digital home appliance determines if a first RFID is present. Then, an electromagnetic wave is broadcasted. The digital home appliance receives a control packet from the batteryless remote control device and operates according to the control packet and a hierarchy information.

### CROSS REFERENCE TO RELATED APPLICATIONS

This application claims the benefit of U.S. Provisional Application No. 60/593,657, filed Feb. 2, 2005.

### BACKGROUND OF THE INVENTION

1. Field of the Invention

This invention generally relates to wireless remote control, especially, to a method of batteryless hierarchical remote control utilizing radio-frequency identification (RFID) technology.

2. Description of the Prior Art

Typically, RFID systems are limited to applications for identification and tracking of persons or things. RFID tags and systems are optimized to reduce the size, power and cost requirements for the RFID tag.

Conventional remote control devices are used for more complex control operations, for example, to remotely control all types of electronic devices and appliances, including televisions, videocassette recorders, cameras and other devices. Remote control devices commonly use infrared or radio frequency wireless data transmission. The conventional remote control device requires an external power source such as two AAA dry batteries.

One problem with traditional remote control devices is the requirement of an integrated or wired power source such as a battery. Batteries do not last forever and their untimely demise is a continuing source of inconvenience and frustration. Another problem, using infrared remote control devices is limited by a control direction between the remote control device and the device being controlled, i.e., the controlled device. Also, batteries cause serious toxic waste problem. Not only is this a problem from the perspective of using the remote control device, but this also limits the location of the infrared receiver in the controlled device. Furthermore, the conventional remote control device might be malfunctioned when it happens to be thrown to the floor when batteries are dislocated, or even might become damaged due to heavy weight.

### SUMMARY OF THE INVENTION

The present invention discloses a batteryless remote control device, comprising a plurality of buttons; an RFID circuit with a nonvolatile memory, coupled to the buttons; and an antenna, coupled to the RFID circuit, for transceiving an RF signal.

The present invention further discloses a remote control method for a batteryless remote control device having an ID to remote control a digital home appliance. The batteryless remote control device receives an electromagnetic wave from the digital home appliance. Then, the received electromagnetic wave is converted to a DC voltage for powering the batteryless remote control device. The batteryless remote control device handshakes with an RFID reader on the digital home appliance, for example. The batteryless remote control device determines if a button is pressed. The batteryless remote control device transmits a control packet associated with the ID in response to the pressed button.

The present invention further discloses a remote control method for a digital home appliance to be remote controlled by a plurality of batteryless remote control devices, each remote control device having an ID. The digital home appliance broadcasts an electromagnetic wave and handshakes with the batteryless remote control devices. The digital home appliance receives a control packet and operates in response to the control packet.

The present invention further discloses a remote control method for a digital home appliance to be remote controlled by a batteryless remote control device. The digital home appliance determines if a first RFID is present. An electromagnetic wave is broadcasted. The digital home appliance receives a control packet from the batteryless remote control device and operates according to the control packet and a hierarchy information, including access control permissions, content control, play-lists, links, personal configuration, saved data etc..

The present invention further discloses a method for a television to program a hierarchy information for a member RFID. The television determines if a golden RFID and the member RFID in a proximity to the television. The television can display a hierarchy information associated with the member RFID. The authorized member can manage the hierarchy information associated with the member RFID through a batteryless remote control device.

The present invention further discloses a method for power saving a television controlled by a batteryless remote control device. Periodically poll an RFID with a long predetermined period if the RFID is out of a first effective range; and periodically poll the RFID with a medium predetermined period if the RFID is in the first effective range.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

This invention is illustrated by means of accompanying drawings. However, these figures represent examples of the invention and do not serve to limit its applicability.

FIG. 1 shows a digital home system capable of being controlled by three batteryless hierarchical remote control devices according to one embodiment of the present invention.

FIG. 2 shows an exemplary block diagram of a batteryless hierarchical remote control device according to one embodiment of the present invention.

FIG. 3 shows an RFID control packet format transmitted by a batteryless remote control device.

FIG. 4 shows a digital home system controlled by a batteryless hierarchical remote control device according to anther embodiment of the present invention.

FIG. 5 shows a digital home system controlled by a batteryless hierarchical remote control device according to anther embodiment of the present invention.

FIG. 6 shows a flowchart of power saving method in a batteryless control system according to a preferred embodiment of the present invention.

FIG. 7 shows an operating flowchart of an RFID reader in a television or a control center according to an embodiment of the present invention.

FIG. 8 shows a flowchart of a batteryless remote control method according to an embodiment of the present invention.

FIG. 9 shows a flowchart of a batteryless remote control method according to an embodiment of the present invention.

FIG. 10 shows a flowchart of a method for a television to program a hierarchy information for a member RFID according to an embodiment of the present invention.

FIG. 11 shows a flowchart of a batteryless remote control method according to another embodiment of the present invention.

FIG. 12 shows a hierarchical remote control device according to another embodiment of the present invention.

FIG. 13 shows a remote finder according to one embodiment of the present invention.

FIG. 14 shows a flowchart of a method for finding a batteryless remote control device according to one embodiment of the present invention.

### DETAILED DESCRIPTION

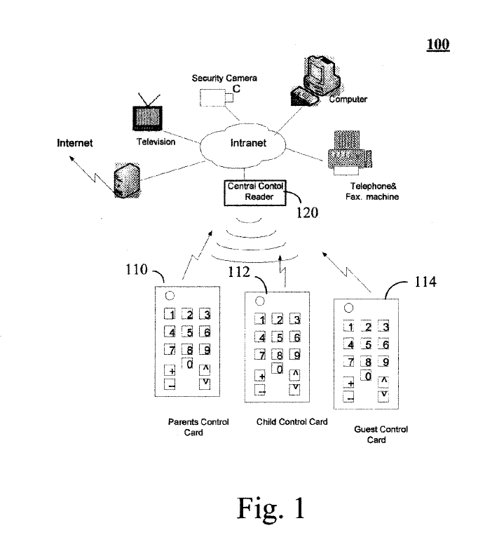

FIG. 1 shows a digital home system 100 capable of being controlled by three batteryless hierarchical remote control devices 110, 112, 114 according to one embodiment of the present invention. The digital home system 100 comprises various digital home appliances, such as several personal computers, a security camera, a television capable of receiving broadcasting programs and internet pay programs, a telephone with fax function. To manage the access right of each member in the family is very important. In this embodiment, the digital home system 100 is intra-connected through the intranet and hierarchically controlled through a central control reader 120. The hierarchical remote control devices 110, 112, 114 are classified into a parents control card 110, a child control card 112 and a guest control card 114, respectively. Different control cards have different access right to the digital home system 100.

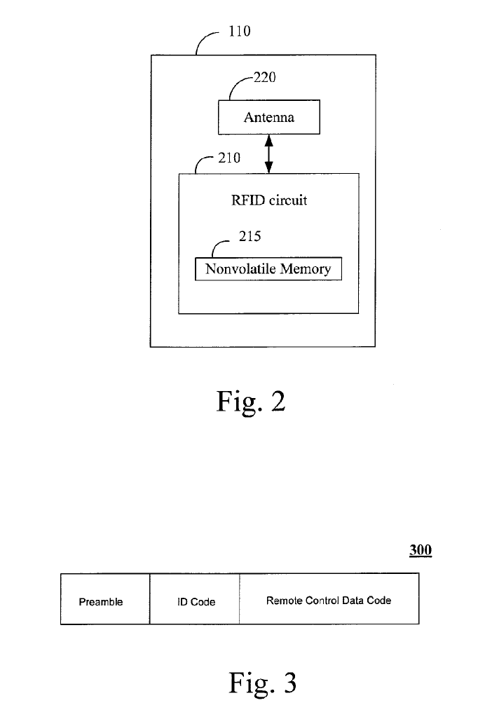

FIG. 2 shows an exemplary batteryless hierarchical remote control device 110, comprising an RFID circuit 210 with a nonvolatile memory 215 and an antenna 220. The RFID circuit 210 couples with the antenna 220. The nonvolatile memory 215, such as ROM (read only memory), fuse, EEPROM (electrically erasable programmable read-only memory), and flash memory etc., records a unique ID number and a hierarchy information, including access control permissions, content control, play-lists, links, personal configuration, saved data etc., which is programmed through the central control reader 120 or through a personal computer with RFID reader function (not shown). Accordingly, for example, parents can prevent their children from dialing pornography telephone numbers and pay phone numbers, and properly manage the quota of pay programs. Through RFID technology, no battery is required and very low cost remote control device 110 can be realized. For example, several keypad buttons and the RFID circuit 210 are required to implement the remote control device 110. Without the constraint of batteries, the remote control device 110 can have many possible shapes and sizes, including pocket or even credit-card sized or smaller, for carrying convenience. Each batteryless remote control device 110, 112, or 114 has a unique ID code. Some control devices are for “mommy/daddy”, others for teens, small children, etc. Each can have certain codes in the ID to provide hierarchy program access rights, based on V-Chip, etc. Each batteryless remote control device 110, 112, or 114 has the unique ID code, which can help set time limits, which can be controlled, for example, by the “mommy/daddy” remote control device to keep track of personal channel preferences, etc. Moreover, for pay TV programs, budgets and program limits can be managed for pay-per-view programs individually. Credit cards for programming payment can be linked to individual remote control device 110, 112, and 114. For example, payment information of credit cards can be properly programmed to a nonvolatile memory and associate with members in the family individually. It should be noted that the hierarchy information can be stored in the nonvolatile memory 215 or in the digital appliance while the ID is stored in the remote control device 110, 112, and 114. Therefore, programming payment becomes quick and secure and is also managed.

FIG. 3 shows an RFID control packet format 300 transmitted by a batteryless remote control device 110, 112, or 114. The control packet format 300 includes a preamble, an ID code, and a data code. Different data codes are transmitted in response to different buttons on the remote control device 110, 112, or 114 pressed by the user. The ID code identifies the individual remote control device 110, 112, or 114.

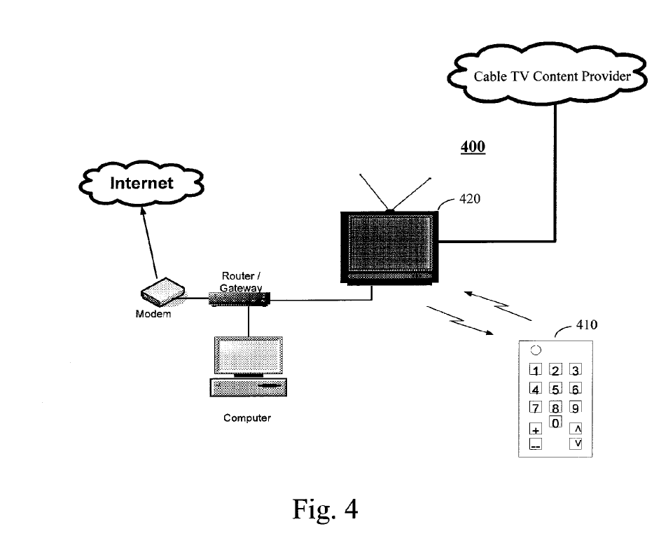

FIG. 4 shows a digital home system 400 controlled by a batteryless hierarchical remote control device 410 according to anther embodiment of the present invention. The television 400 can receive programs from the Internet or a cable TV content provider. Computer/Internet/digital communications link can be individually managed, such as custom limits of programming and time. Preferably, the television 400 is integrated with an RFID reader (not shown). An authorized user can manage the rights of watching TV programs for each identified user directly through the television 400.

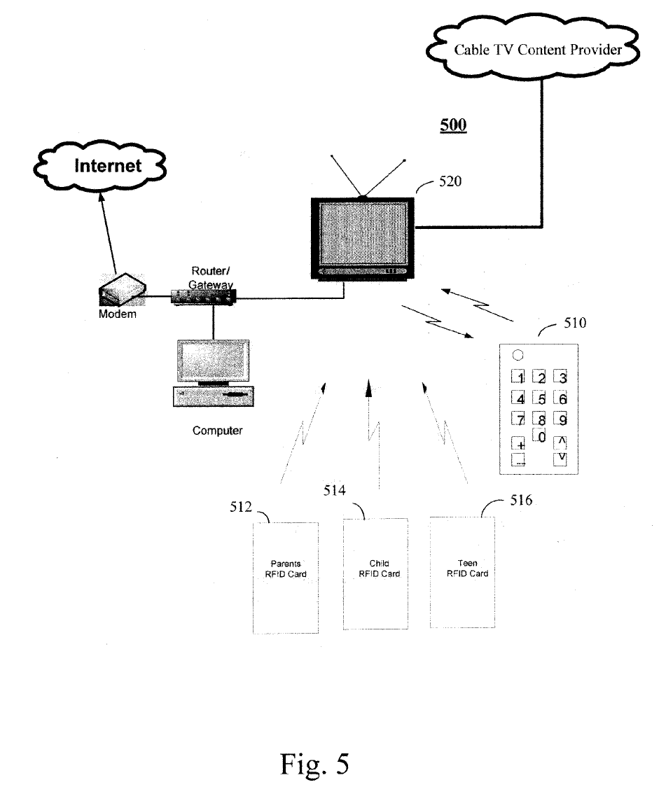

FIG. 5 shows a digital home system 500 controlled by a batteryless hierarchical remote control device 510 according to anther embodiment of the present invention. The television 500 can receive programs from the Internet or a cable TV content provider. In this embodiment, the retailer sells the television 500 equipped with the remote control device 510 and a parents RFID card 512 (or called “golden” RFID card) to the consumer, wherein the remote control device 510 has control buttons thereon and is shared by all members in the family to control the television 500. The television 500 is integrated with an RFID reader and the remote control device 510 is integrated with an RFID circuit (not shown). Similarly, individual data code is transmitted to control the television 500 in response to individual button on the remote control device 510 pressed by a user. The RFID reader in the television 500 (or a digital home appliance) records hierarchy information in a nonvolatile memory therein. Therefore, the remote control device 510 can hierarchically control the television 500 according to the hierarchy information in the RFID reader by determining if the parents RFID card 512, the child RFID card 514 and/or the teen RFID card 516 are near the television 500. RFID technology benefits from the limited effective distance detection in a family. As known, batteryless RFID effective distance is normally 3 to 10 meters without obstruction. In a living room of a house, the batteryless remote control device 510 integrated with the RFID circuit can hierarchy-remote control without suffering directional sensitivity. Since the RFID cards 512, 514, 516 are small sized, every member can keep his card easily. When parents are outdoors or even in different room, the parents RFID card 512 is out of effective range for the television 500. The parents right to manage the hierarchy information for the television 500 is prohibited accordingly. For example, if only one child carrying his child RFID card 514 sits in the living room, the television 500 detects only the child RFID card 514 is present, so the child can only access those programs defined by the hierarchy information in the RFID reader. Preferably, a shorter RFID effective distance can be manually adjusted through the television 500.

In FIG. 5, the parents RFID card 512 has the authority to define the hierarchy information in the RFID reader of the television 500. Preferably, the RFID cards 512, 514, 516 can be “linked” to the television 500, or even a home appliance, by an “introduction” procedure. When the parents place the parents RFID card 512 and a RFID card 514 in very close proximity to the television 500. “Proximity” is detected by strength of RF-signal received from the parents RFID card 512 and the new RFID card 514. Then television 500 preferably displays information associated with these two RFID cards to confirm the introduction procedure and the parents can perform hierarchy management through the remote control device 510 because the parents RFID card 512 is detected as proximity to the television 500. Then the new RFID card 514 can be managed as a child RFID card 514 with child hierarchy. Proximity detection of RFID cards facilitates parents to manage the hierarchical control right on the television screen very easily. Moreover, a password or a biometric identification, such as a fingerprint, can be further required before performing hierarchy management. This not only confirms the user intent, but also prevents someone who cannot see the TV screen from using the introduction procedure. The remote control device 510 is placed in the living room and shared by all members in the family. As noted, the remote control device 510 requires no battery, weights light, and can be very thin. The remote control device 510 is not afraid to be thrown to the floor by accident and has no problem about imperfect battery installation. Moreover, since the size of the remote control device 510 is small, the remote control device 510 is also easier to be collected in a small area without damaging the wood surface of the desk.

According to the above disclosure, persons skilled in the art can appreciate that the hierarchy information, including access control permissions, content control, play-lists, links, personal configuration, and saved data etc., for the RFID cards 512, 514, 516 can be managed through an RFID reader equipped on a television or even a computer. Also, the hierarchy information can be managed by one RFID card for each member for all digital home appliances. The hierarchy information also defines a pay quota for each member for internet pay programs. Preferably, the proximity detection of the introduction procedure is performed to facilitate management.

In FIG. 5, again, power consuming of the RFID reader of the television 500 is further considered. The RFID reader should transmit electromagnetic wave to detect the presence of the RFID card 512, 514, or 516. If the RFID reader efficiently transmits electromagnetic wave 24 hours a day, it wastes power. Preferably, the RFID reader may poll the RFID cards with short, medium, or long predetermined period. The RFID reader polls the remote control device 510 with the short predetermined period, i.e. fastest frequency, 100 ms, for example, when the television 500 has been turned on. 100 ms human response time for button press, so polling period may be around every 100 ms. Of course, if the user stays at the same channel for a long time, the polling period can be extended a little, but it should be noted that the user is still there. More importantly, after the television 500 is turned off, the RFID reader of the television 500 starts detecting if any RFID card is in effective range, preferably periodically.

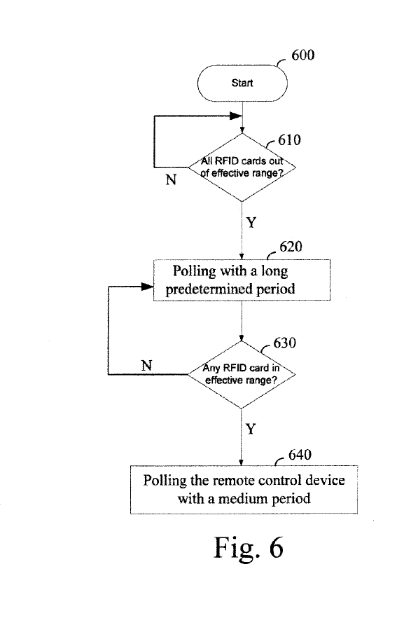

FIG. 6 shows a flowchart of power saving method in a batteryless control system according to a preferred embodiment of the present invention. The flowchart starts at step 600. At step 610, once the RFID reader determines all RFID cards are out of effective range, probably every member goes outdoors, proceed to step 620. At step 620, the RFID reader of the television 500 can save power by polling with the long predetermined period, i.e. slowest frequency, 5 seconds, for example. It should be noted that it is seldom for a person to go home and directly turn on the television in such a hurry. The RFID reader of the television 500 might happen to determine the person coming home once he is unlocking the door. At step 630, once the RFID reader of the television 500 detects any of RFID cards 512, 514, and 516 in the effective range, the RFID reader should poll the remote control device 510 with the medium period, 2 seconds, for example. At step 640, the RFID reader may poll the remote control device 510 with the medium period or the short period according to the distance between the user and the television 500 by detecting the RF signal strength and the frequency the user appears in the effective range. Preferably, the effective range of any user appearance is larger than the effective range of the user usage of the television 500 mentioned above. For example, the television 500 determines a user appears within a first effective range of 12 meters and determines a certain user is using the television 500 when the user is within a second effective range of 5 meters by detecting the RF signal strength reflected from the user RFID card 512, 514, or 516.

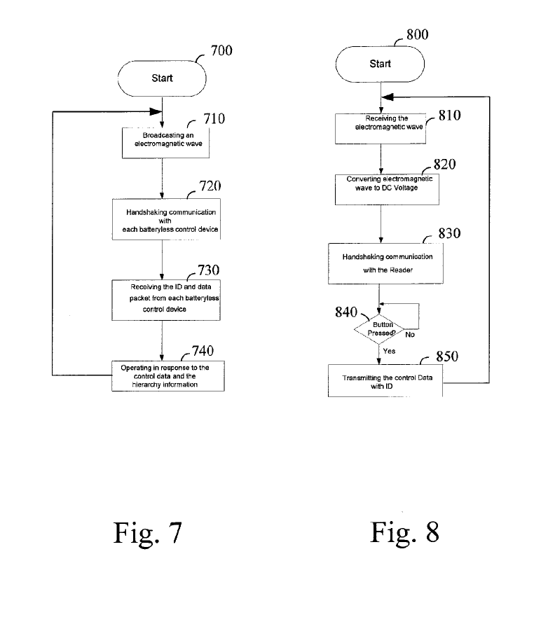

FIG. 7 shows an operating flowchart of an RFID reader in a television or a control center 120 as shown in FIG. 1, and FIG. 8 shows a flowchart of a batteryless remote control method according to an embodiment of the present invention. Please refer to FIG. 7 accompanying with FIG. 1. FIG. 7 starts at step 700. At step 710, a RFID reader in the control center 120 (i.e. a central control RFID reader), or in the television periodically broadcasts the electromagnetic wave to the remote control devices 110 112 and/or 114. At step 720, the control center 120 handshakes with each batteryless control device 110, 112 and/or 114. At step 730, the control center 120 receives the ID and data packet from each batteryless control device 110, 112 and/or 114. At step 740, the control center 120 operates according to the control data and the hierarchy information. After that, repeat the flowchart from step 710.

Please refer to FIG. 8 accompanying with FIG. 1. Take the remote control device 110 in FIG. 1 as an example for explanation. FIG. 8 starts at step 800. At step 810, the remote control device 110 receives the electromagnetic wave. At step 820, the remote control device 110 converts the electromagnetic wave to DC voltage. At step 830, the remote control device 110 handshakes with the control center 120. At step 840, determines if any button on the remote control device 110 is pressed. If yes, proceed to step 850 and transmit the control data with the unique ID in response to the pressed button. Otherwise, repeat step 840 to keep detecting if any button on the remote control device 110 is pressed.

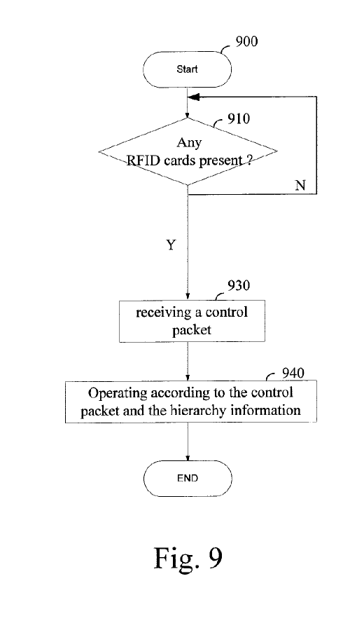

Moreover, FIG. 9 shows a flowchart of a batteryless remote control method according to an embodiment of the present invention. Please refer to FIG. 9 accompanying with FIG. 5. The flowchart starts from step 900. At step 910, detect all RFID cards (or tags) present in the effective range. For example, if there are five members in a family and only three members are sitting in front of the television 520, then three RFID cards are detected in the effective range. The television 520, for example, broadcasts an electromagnetic wave to the batteryless remote control device 510. At step 930, the television 520, for example, receives a control packet from the batteryless remote control device 510. At step 940, the television 520 operates according to the control packet and a hierarchy information. The hierarchy information is preferably stored in the television 520. The control packet includes a preamble, an ID code, and a data code. The control packet associates with a button of the control device pressed by a user. The hierarchy information defines a plurality of hierarchy access rights for members in the family, including a parents access right, a child access right and a teen hierarchy access right. Each RFID associates with one of the hierarchy access rights. Preferably, when there are several RFID cards are detected, the highest hierarchy access right therein is allowed. Preferably, the television 520 operates according to the control packet and the hierarchy information associated with a normal hierarchy access right when no RFID is detected. For example, a guest has no RFID. The normal hierarchy access right might be the lowest hierarchy among all hierarchy access rights.

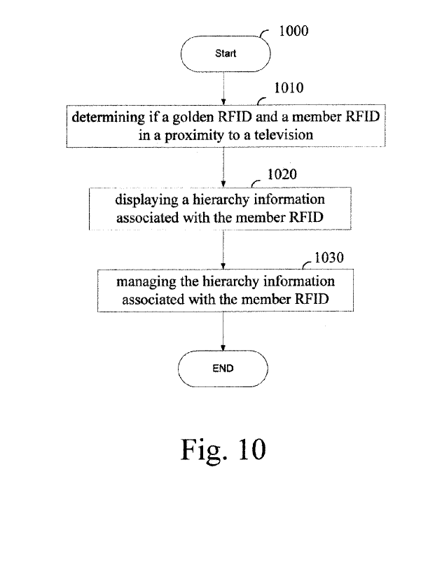

FIG. 10 shows a flowchart of a method for a television to program a hierarchy information for a member RFID according to an embodiment of the present invention. Please refer to FIG. 10 accompanying with FIG. 5. The flowchart starts from step 1000. At step 1010, an authorized member, usually father, places a golden RFID and the member RFID in a proximity to the television 520. “Proximity” is determined according to the power strength of RF signal coming from the golden RFID and the member RFID. At step 1020, the television 520 displays a hierarchy information associated with the member RFID. At step 1030, the authorized member manages the hierarchy information for the member RFID through the batteryless remote control device 510. Preferably, before managing the hierarchy information, a password or a biometric identification, such as a fingerprint, is requested by the television 520 to confirm the authorized identity.

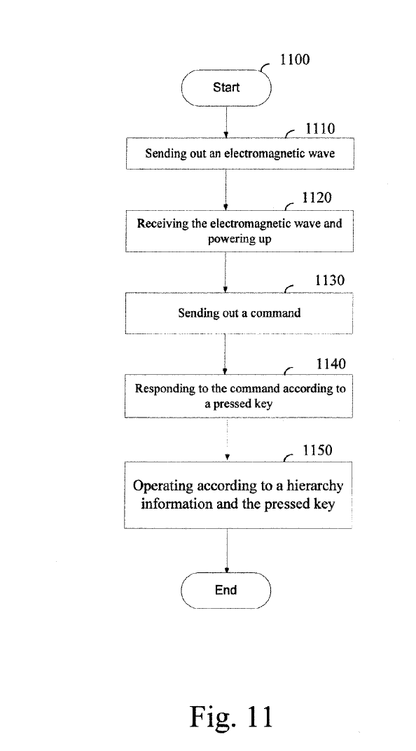

FIG. 11 shows a flowchart of a batteryless remote control method according to another embodiment of the present invention. The flowchart starts from step 1100. At step 1110, an RFID reader sends out an electromagnetic wave. Next, at step 1120, a batteryless remote control device receives the electromagnetic wave and powers up accordingly. At step 1130, the RFID reader sends out a command. At step 1140, the batteryless remote control device responds to the command according to a pressed key. Preferably, the response made by the batteryless remote control device includes “None,” “Null(ACK),” “ID code,” and “key code” etc.. At step 1150, a digital home appliance operates according to the pressed key and a hierarchy information, including access control permissions, content control, play-lists, links, personal configuration, pay quota and saved data etc.,.

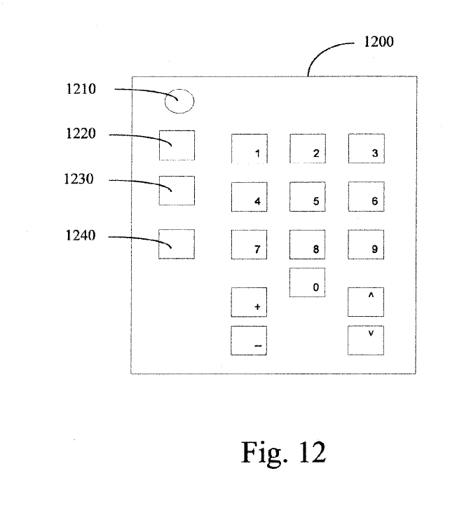

FIG. 12 shows a hierarchical remote control device 1200 according to another embodiment of the present invention. The remote control device 1200 can achieve hierarchical remote control with or without batteries, by utilizing, for example, RFID technology or infrared. The hierarchical remote control device 1200 comprises a power-on key 1210, a plurality of hierarchy keys 1220, 1230, 1240, a plurality of control keys. For example, the power-on key 1210 is pressed to turn on or off a digital home appliance, such as a television, and three hierarchy keys represent parents, teens, and child hierarchies, respectively. Preferably, when one of hierarchy keys is pressed, identification authentication is required, such as a password or a biometric identification, such as a fingerprint, or RFID identification. After the identification authentication is confirmed, the user can control the television under his own hierarchy. The hierarchical remote control device 1200 transmits an electromagnetic wave and the television operates according to a hierarchy information in response to the electromagnetic wave. The hierarchy information resides, for example, in the television, including access control permissions, content control, play-lists, links, personal configuration, pay quota and saved data etc.,. Therefore, children can not access the parents' hierarchy control. Thus, children's access right to the digital home appliances is managed by parents. Preferably, the hierarchical remote control device 1200 transmits the electromagnetic wave to control the television according to a personal configuration.

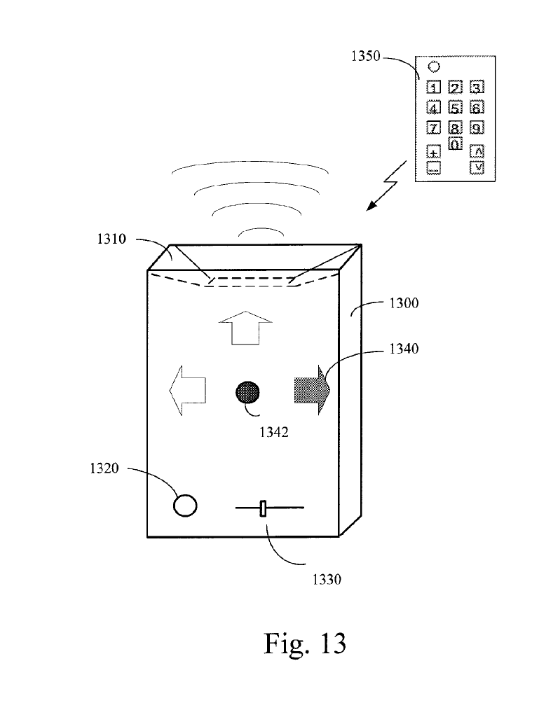

FIG. 13 shows a remote finder 1300 according to one embodiment of the present invention. The remote finder 1300 comprises a wave-guide antenna 1310, a button 1320, a strength adjuster 1330, a plurality of direction indicators 1340 and a closing indicator 1342. The remote finder 1300 is embedded with a simplified RFID reader (not shown), coupled to the antenna 1310 and the button 1320, and is capable of helping a user to locate a lost batteryless remote control device 510 or a lost RFID card 512, 514 or 516 in FIG. 5. When the user wants to locate the lost remote control device 510, he can press the button 1320 to signal the embedded RFID reader to excite an electromagnetic wave through the wave-guide antenna 1310. Preferably, the user can adjust the signal strength of the electromagnetic wave through the strength adjuster 1330. If the lost remote control device 510 is within the effective range of the electromagnetic wave, the lost remote control device 510 is powered by receiving the electromagnetic wave and replies a signal response accordingly. The remote finder 1300 properly lights the direction indicators 1340 to indicate the direction of the lost remote control device 510 according to the direction of the signal response. Moreover, the remote finder 1300 can turn on the closing indicator 1342 to notify the user that the lost remote control device 510 is very close when the RFID reader determines the remote control device 510 is within a predetermined range according to the power strength of the signal response. It should be noted that the arrangement of indicators 1340 and 1342 can be modified in different ways by persons skilled in the art. For example, the closing indicator 1342 can be reduced by twinkling the direction indicators 1340 to notify the user. Also, the number of direction indicators 1340 can be increased and arranged in a circle shape to indicate the direction of the remote control device 510 more clearly. The remote finder 1300 could be implemented by the RFID reader in the television 520 and display the direction on its screen to help find out the missing remote control device 510.

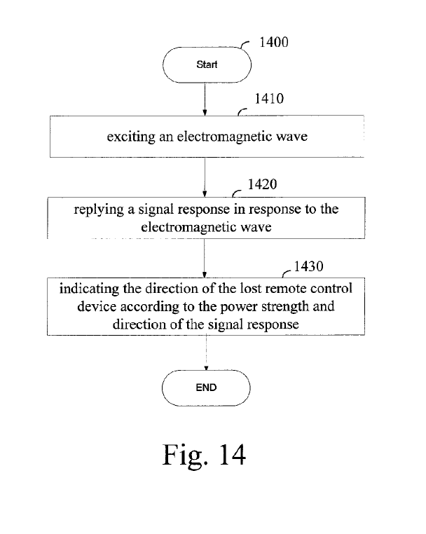

FIG. 14 shows a flowchart of a method for finding a batteryless remote control device according to one embodiment of the present invention. Please refer to FIG. 14 accompanying FIG. 5. The flowchart starts at step 1400. At step 1410, an electromagnetic wave is excited by an RFID reader, which can be implemented as a stand alone portable device or in the television 520. To find the batteryless remote control device 510, at step 1420, the batteryless remote control device 510 is powered by the received electromagnetic wave and replies a signal response in response to the electromagnetic wave. At step 1430, the direction of the lost remote control device is indicated according to the power strength and direction of the signal response. The direction of the lost remote control device can be indicated through a plurality of indicators or directly on the screen of the television 520.

Overall, the present invention discloses a remote control system, comprising a digital home appliance with an RFID reader for sending out an electromagnetic wave; and a batteryless remote control device, for receiving the electromagnetic wave and powering up. The RFID reader sends out a command and the remote control device responds to the command according to a pressed key. The batteryless remote control device responds a control packet including an ID code and a data code. The digital home appliance operates according to a hierarchy information and the pressed key. The hierarchy information includes a plurality of access control permissions, a content control, a plurality of play-lists, a plurality of links, a plurality of personal configurations, a pay quota and saved data. Preferably, a biometric identification is verified before managing the hierarchy information.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A batteryless remote control device, comprising:
a plurality of buttons;
an RFID (radio-frequency identification) circuit with a nonvolatile memory, coupled to said buttons; and
an antenna, coupled to said RFID circuit, for transceiving an RF (radio-frequency) signal.

2. The batteryless remote control device of claim 1, wherein when one of said buttons is pressed, said RFID circuit transmits a control packet, including a preamble, an ID code, and a data code, in response to said pressed button.

3. The batteryless remote control device of claim 1, wherein said RFID circuit is powered by said RF signal received by said antenna.

4. The batteryless remote control device of claim 1, wherein said nonvolatile memory stores a hierarchy information for a user.

5. The batteryless remote control device of claim 4, wherein said control packet associates with said hierarchy information.

6. The batteryless remote control device of claim 5, wherein said hierarchy information defines an access right to a digital home appliance for said user.

7. A remote control method for a batteryless remote control device having an ID to remote control a digital home appliance, comprising steps of:
receiving an electromagnetic wave;
converting said electromagnetic wave to a DC voltage;
handshaking with an RFID reader; and
transmitting a control packet associated with said ID in response to a pressed button.

8. The remote control method of claim 7 further comprising a step of said digital home appliance operating in response to said control packet.

9. The remote control method of claim 7 wherein said RFID reader is integrated in said digital home appliance.

10. The remote control method of claim 7 wherein said transmitting step transmits said control packet according to a hierarchy information.

11. The remote control method of claim 10 wherein said hierarchy information includes a plurality of access control permissions, a content control, a plurality of play-lists, a plurality of links, a plurality of personal configurations, a pay quota and saved data.

12. A remote control method for a digital home appliance to be remote controlled by a plurality of batteryless remote control devices, each remote control device having an ID, comprising steps of:
broadcasting an electromagnetic wave;
handshaking with said batteryless remote control devices;
receiving a control packet; and
said digital home appliance operating in response to said control packet.

13. The remote control method of claim 12 wherein said control packet includes a preamble, an ID code, and a data code.

14. The remote control method of claim 12 wherein said control packet associates with a pressed button.

15. The remote control method of claim 12 wherein said digital home appliance operates according to said control packet and a hierarchy information.

16. A remote control method for a digital home appliance to be remote controlled by a batteryless remote control device, comprising steps of:
determining if a first RFID is present;
broadcasting an electromagnetic wave;
receiving a control packet from said batteryless remote control device; and
said digital home appliance operating according to said control packet and a hierarchy information.

17. The remote control method of claim 16 wherein said control packet includes a preamble, an ID code, and a data code.

18. The remote control method of claim 16 wherein said control packet associates with a button of said control device pressed by a user.

19. The remote control method of claim 16 wherein said hierarchy information is stored in said digital home appliance.

20. The remote control method of claim 16 wherein said first RFID resides in an RFID card.

21. The remote control method of claim 16 wherein said hierarchy information associates with said first ID.

22. The remote control method of claim 16 wherein said hierarchy information defines a parents access right, a child access right and a teen hierarchy access right.

23. The remote control method of claim 16 wherein said hierarchy information defines a plurality of hierarchy access rights.

24. The remote control method of claim 23 further comprising a step of determining if a second RFID is present.

25. The remote control method of claim 24 wherein each RFID associates with one of said hierarchy access rights.

26. The remote control method of claim 25 wherein said digital home appliance operates according to said control packet and said hierarchy information associates with a higher hierarchy access right of said first ID and said second ID when said first RFID and said second RFID are both present.

27. The remote control method of claim 16 wherein said digital home appliance operates according to said control packet and said hierarchy information associated with a normal hierarchy access right when no RFID is detected.

28. The remote control method of claim 27 wherein said normal hierarchy access right is a lowest hierarchy access right.

29. A method for a television to program a hierarchy information for a member RFID, comprising steps of:
determining if a golden RFID and said member RFID in a proximity to said television;
displaying a hierarchy information associated with said member RFID on said television; and
managing said hierarchy information associated with said member RFID.

30. The method of claim 29 wherein said proximity is determined according to a first strength of a first RF signal coming from said golden RFID and a second strength of a second RF signal coming from said member RFID.

31. The method of claim 29 wherein a password is required before managing said hierarchy information.

32. The method of claim 29 wherein a biometric identification is verified before managing said hierarchy information.

33. The method of claim 29 wherein said managing step manages said hierarchy information associated with said member RFID through a remote control device.

34. The method of claim 29 wherein said remote control device has an RFID circuit and a plurality of buttons and is batteryless.

35. The method of claim 29 wherein said hierarchy information defines a time limit associated said member RFID.

36. The method of claim 29 wherein said hierarchy information defines a program limit associated said member RFID.

37. The method of claim 29 wherein said hierarchy information records a payment information of a credit card associated said member RFID.

38. The method of claim 29 wherein said hierarchy information defines a pay quota associated said member RFID.

39. The method of claim 38 wherein said pay quota defines a pay quota for internet pay programs associated said member RFID.

40. A method for power saving a television controlled by a batteryless remote control device, comprising steps of:
periodically polling an RFID with a long predetermined period if said RFID is out of a first effective range; and
periodically polling said RFID with a medium predetermined period if said RFID is in said first effective range.

41. The method of claim 40 wherein said first effective range is adjustable.

42. The method of claim 40 wherein said television determines if said RFID is in said first effective range according to a power strength of an RF signal received from said RFID.

43. The method of claim 40 further comprising a step of polling said RFID in a short predetermined period if said RFID is in a second effective range.

44. The method of claim 43 wherein said first effective range is larger than said second effective range.

45. The method of claim 43 wherein said second effective range is adjustable.

46. The method of claim 43 further comprising a step of polling said batteryless remote control device if said RFID is in said second effective range.

47. A batteryless remote control method comprising steps of:
sending out an electromagnetic wave;
receiving said electromagnetic wave and powering up;
sending out a command; and
responding to said command according to a pressed key.

48. The method of claim 47 wherein said responding step responds a control packet including an ID code and a data code.

49. The method of claim 47 further comprising a step of a digital home appliance operating according to a hierarchy information and said pressed key.

50. The method of claim 49 wherein said hierarchy information includes a plurality of access control permissions, a content control, a plurality of play-lists, a plurality of links, a plurality of personal configurations, a pay quota and saved data.

51. The method of claim 49 wherein a biometric identification is verified before managing said hierarchy information.

52. A hierarchical remote control device comprising:
a power-on key;
at least one hierarchy key; and
a plurality of control keys,
wherein said at least one hierarchy key associates with a hierarchy information.

53. The hierarchical remote control device of claim 52 wherein said hierarchical remote control device is batteryless.

54. The hierarchical remote control device of claim 52 wherein said hierarchical remote control device is an infrared remote control device.

55. The hierarchical remote control device of claim 52 wherein each hierarchical key represents a hierarchy right.

56. The hierarchical remote control device of claim 55 wherein each hierarchy right requires an identification authentication.

57. The hierarchical remote control device of claim 56 wherein said identification authentication requires a password.

58. The hierarchical remote control device of claim 56 wherein said identification authentication requires a biometric identification.

59. The hierarchical remote control device of claim 56 wherein said identification authentication requires an RFID.

60. The hierarchical remote control device of claim 52 wherein said hierarchical remote control device transmits an electromagnetic wave to control a digital home appliance according to a personal configuration.

61. The hierarchical remote control device of claim 52 wherein said hierarchical remote control device transmits an electromagnetic wave to control a digital home appliance.

62. The hierarchical remote control device of claim 60 wherein said digital home appliance operates according to said hierarchy information in response to said electromagnetic wave.

63. The hierarchical remote control device of claim 61 wherein said hierarchy information includes a plurality of access control permissions, a content control, a plurality of play-lists, a plurality of links, a plurality of personal configurations, a pay quota and saved data.

64. A remote finder for finding a batteryless remote control device, comprising:
a wave-guide antenna;
a button;
a plurality of indicators; and
an RFID reader, coupled to said antenna, said indicators and said button,
wherein said RFID reader excites an electromagnetic wave through the wave-guide antenna when said button is pressed and said indicators indicate a direction of said batteryless remote control device according to a signal response from said batteryless remote control device.

65. The remote finder of claim 64 further comprising a signal strength adjuster, coupled to said RFID reader, for adjusting a strength of said electromagnetic wave.

66. The remote finder of claim 64 wherein said direction of said remote control device is determined according to a direction of the signal response.

67. The remote finder of claim 64, wherein said indicators further indicate if said batteryless remote control device is within a predetermined range.

68. The remote finder of claim 67, wherein said indicators comprises:
a plurality of direction indicators to indicate said direction of said batteryless remote control device; and
a closing indicator to indicate if said batteryless remote control device is within said predetermined range.

69. The remote finder of claim 68, wherein said direction indicators are arranged in a circle shape.

70. A method for finding a batteryless remote control device comprising steps of:
exciting an electromagnetic wave;
replying a signal response in response to said electromagnetic wave; and
indicating a direction of said remote control device according to a direction of said signal response.

71. The method of claim 70 further comprising a step of indicating if said remote control device is within a predetermined range according to a signal strength of said signal response.

72. A remote control system, comprising:
a digital home appliance with an RFID reader for sending out an electromagnetic wave; and
a batteryless remote control device, for receiving said electromagnetic wave and powering up;
wherein said RFID reader sends out a command and said remote control device responds to said command according to a pressed key.

73. The remote control system of claim 72 wherein said batteryless remote control device responds a control packet including an ID code and a data code.

74. The remote control system of claim 72 wherein said digital home appliance operates according to a hierarchy information and said pressed key.

75. The remote control system of claim 74 wherein said hierarchy information includes a plurality of access control permissions, a content control, a plurality of play-lists, a plurality of links, a plurality of personal configurations, a pay quota and saved data.

76. The remote control system of claim 74 wherein a biometric identification is verified before managing said hierarchy information.
